(19) United States
(12) Patent Application Publication
(10) Pub. No.: US 2024/0059978 A1
(43) Pub. Date: Feb. 22, 2024

(54) One-step process for the production of hydrocarbons from carbon dioxide

(71) Applicant: Infinium Technology, LLC, Sacramento, CA (US)

(72) Inventors: Robert Schuetzle, Sacramento, CA (US); Dennis Schuetzle, Grass Valley, CA (US); Anja Rumplecker Galloway, San Rafael, CA (US); Orion Hanbury, Sacramento, CA (US); Harold Wright, Menomonee Falls, WI (US)

(73) Assignee: Infinium Technology, LLC, Sacramento, CA (US)

(21) Appl. No.: 18/445,376

(22) Filed: Aug. 4, 2023

Related U.S. Application Data
(60) Provisional application No. 63/474,544, filed on Aug. 22, 2022.

(51) Int. Cl. C10G 2/00; B01J 23/72; B01J 23/745; B01J 23/89; B01J 35/10

(52) U.S. Cl. CPC C10G 2/50; B01J 23/72; B01J 23/745; B01J 23/8906; B01J 35/1014; C10G 2300/70

(57) ABSTRACT

The present invention are new and improved processes and catalysts that can efficiently facilitate the direct carbon dioxide conversion reaction with hydrogen to hydrocarbons in a single reactor at temperatures less than 450° C. and more preferably at temperatures from 250° C. to 325° C. Carbon dioxide is utilized from stationary sources or from direct air capture. Hydrogen is produced by the electrolysis of water using renewable or low carbon electricity.

### CROSS-REFERENCE TO RELATED APPLICATION

This application claims the benefit of U.S. Provisional Patent Application No. 63/474,544, filed Aug. 22, 2022, which is incorporated by reference herein in its entirety.

### FIELD OF THE INVENTION

The field of the invention is a process to produce hydrocarbons from CO₂ including sustainable aviation fuel (SAF) or diesel fuel by using a new lower temperature CO₂C reaction in a new direct integrated process to produce hydrocarbons.

### BACKGROUND OF THE INVENTION

The increase in global atmospheric carbon dioxide (CO₂) concentrations has been linked to changes in the earth's climate. The combustion of fossil fuels in various engines and heaters produces atmospheric CO₂. Concerns about climate change have led to significant societal changes toward renewable or low carbon electricity. This has also led to increasing activity to decarbonize the economy.

Electricity can be used to produce synthetic methane, kerosene, methanol, or other chemicals, which can be gases or liquids, also known as power-to-gas, power-to-chemicals, or more generally power-to-X processes (PtX, P2X). Electrical power produced from solar, wind or other sustainable sources is commonly called decarbonized electricity. Fuels and chemicals produced using decarbonized electricity results in low, zero or negative overall CO₂ emissions. This raw (feedstock) material differentiates e-fuels from biofuels, which are primarily produced from biomass where often the biomass used comprises food feedstocks or feedstocks that have negative environmental impacts (e.g., canola oil, palm oil, others)

The state-of-the-art process is to convert hydrogen from electrolysis and CO₂ to produce syngas, a mixture of carbon monoxide and hydrogen, and to use the syngas to produce fuels and chemicals. The thermodynamics of the RWGS reaction requires a high temperature of approximately 800-900° C. at the RWGS reactor inlet to drive the reaction. This process often requires large electrical heaters with large electrical demands, as the syngas formation reaction is highly endothermic (i.e., requiring a substantial, continuous input of heat). In addition, the subsequent reaction of syngas to fuels (including both/either hydrocarbons and/or alcohols) is highly exothermic—giving off a heat of reaction that needs to be removed continuously from the reactor system. Thus, the state-of-the-art requires the simultaneous provision of input heat in the syngas formation step, and removal of heat in the syngas conversion step. Although the latter partially offsets the former, the net requirement is an input of heat to facilitate the integrated process. Furthermore, and of great practical significance, the process management of these two heat effects presents engineering and operational challenges—with resultant deleterious impacts on both process efficiency and capital cost requirements.

Various Power-to-X (PtX) concepts depend on the utilization of renewable or low-carbon electricity to produce hydrogen through the electrolysis of water. This hydrogen can be used directly as a final energy carrier or it can be converted into, for example, methane, synthesis gas, liquid fuels, electricity, or chemicals.

There has been some limited previous work on performing the CO₂C reaction to C₅+ hydrocarbons at temperatures less than 450° C.

Most of the effort to convert CO₂ to liquid hydrocarbon fuels in a single step (usually manifest as a single reactor) has focused on the development of a catalyst that first generates CO from CO₂ by hydrogenation and then reacts with H₂ on the same catalyst or a catalyst in tandem (close physical proximity) to form liquid hydrocarbons. The proximity of the two reaction sites is ideally close enough that the benefit of heat integration can be directly realized, at least in part.

To date, most research has focused on the use of iron-based catalysts, which are active for the reverse water gas-shift reaction and F-T chemistry (National Academy of Sciences, 2019).

Pan et al. (2007) described the use of an Rh catalyst supported on carbon nanotubes in a tubular reaction to produce ethanol from mixtures of CO₂ and H₂ at a very low space velocity of about 13 hr⁻¹. In addition to ethanol, this catalyst produced a complex mixture of oxygenated hydrocarbons including methanol, acetaldehyde, acetone, isopropanol, and acetic acid. The problem with this catalyst is that it is not amenable to scale up to commercial size due to a high catalytic reactor pressure drop, the very low space velocity, and the production of a complex mixture of oxygenated hydrocarbons, which would need substantial post processing to produce specific products that are viable in the commercial marketplace.

Wang et al. (2019) described a Fe/ZrO₂ catalyst for catalyzing the hydrogenation of CO₂ that produced primarily CH₄ and C₂-C₄ paraffins. The selectivity for production of liquid-phase hydrocarbons was very low.

Landau et al (2015) described a 20% Fe₂O₃ on iron-spinel catalyst. The catalyst particle size varied from 100 um to 3.0 mm. This catalyst was tested using H₂/CO₂ with a ratio of 2.0-3.0/1.0; a very low space velocity of about 2.0 hr⁻¹; a temperature of 325-350° C.; and a pressure of 20-40 atmospheres. The maximum conversion of CO₂ was 36%. The selectivity of the products was: CO (13%), CH₄ (9%), C₂-C₅ (44%) and C₆-C₂₇ HC's (25%). The olefin/paraffin ratio of the C₆+ hydrocarbons was about 5/1. This catalyst is not commercially viable since it operates at a very low (2.0 hr⁻¹) space velocity.

Wei et al. (2018) described an iron-based catalyst for the one-step conversion of CO₂ into iso-paraffins. The conversion efficiency of CO₂ was only 26% with a low CO selectivity of about 17%. Coke (carbon) deposition inside the micro-pores of the catalyst caused a rapid decline of iso-paraffin yield with time.

Williamson et al. (2019) described the performance of a one-step catalyst comprised of iron nanoparticles deposited on carbon nanotubes. The catalysts were calcinated at 400° C. for 1 hour or 570° C. for 40 minutes in air and activated with H₂ at 400° C. for 3 hours. The catalysts were tested in laboratory reactors at 370° C. and 221 psi using a H₂/CO₂ mixture of 3.0/1.0. The average CO₂ conversion was 54% with CO and hydrocarbon selectivities of 30% and 70%, respectively. The average composition of the hydrocarbon products was 43% CH₄, 55% C₂-C₄ and 2.0% C₅+ hydrocarbons, by mass.

Wang et al (2021) described a one-step, plasma-enabled catalytic process to convert CO₂ into hydrocarbons. They found that this process can convert CO₂ with a conversion of up to about 70% with a hydrocarbon selectivity up to about 45% at about 250° C. However, only C₁-C₅ hydrocarbons were produced with methane and C₂-C₅ selectivities of 65-70% and 30-35%, respectively. The high amount of methane produced limits the practical value of this approach.

Shen et al. (2022) synthesized a nickel-cerium solid solution catalyst that was found to form CO with a high selectivity (>95%) at 300° C. However, only 10% of the CO₂ was converted to CO and this conversion declined over a period of about 100 hours.

Yao et al. (2020) synthesized a Fe—Mn—K catalyst for the direct conversion of CO₂ and H₂ mixtures to C₅+ hydrocarbons. This catalyst was tested at an H₂/CO ratio of 3/1, at 300° C., 150 psi, and a space velocity of 2,400 hr⁻¹. The CO₂ conversion declined from 37-34% over a 75-hour test period which indicates that the catalyst was deactivating. The C₅+ hydrocarbon yield was about 22%.

The objective of the present invention is to take advantage of new and improved processes and catalysts that can facilitate the direct CO₂ conversion (CO₂C) reaction to hydrocarbons at temperatures less than 450° C. and more preferably at temperatures from 250° C. to 325° C.

### BRIEF SUMMARY OF THE INVENTION

This invention is an improved process for the production of low carbon fuels and chemicals taking advantage of new and improved catalysts that can perform the CO₂C reaction at temperatures from 250° C. to 325° C.

In one embodiment, a process for the production of hydrocarbons is provided. The process involves: mixing a first feed stream comprising CO₂ with a second feed stream comprising renewable H₂ to produce a CO₂ reactor feed stream; and, feeding the CO₂ reactor feed stream into a CO₂ conversion reactor, wherein the CO₂ conversion reactor comprises two catalysts, thereby producing a reactor product stream comprising C⁵⁺ hydrocarbons, H₂O and unreacted H₂, CO and CO₂.

In another embodiment, a process for the production of hydrocarbons is provided. The process involves: mixing a first feed stream comprising CO₂ with a second feed stream comprising renewable H₂ to produce a CO₂ reactor feed stream; and, feeding the CO₂ reactor feed stream into a CO₂ conversion reactor, wherein the CO₂ conversion reactor is a multi-tubular fixed bed reactor, and wherein the CO₂ conversion reactor comprises two catalysts, wherein one of the catalyst comprises Fe₃O₄ impregnated with copper, thereby producing a reactor product stream comprising C⁵⁺ hydrocarbons, H₂O and unreacted H₂, CO and CO₂.

### BRIEF DESCRIPTION OF THE DRAWINGS

FIG. 1 shows the process of converting CO₂ and hydrogen to hydrocarbons using a CO₂C reactor, where the components are: Stream 1—low-carbon electric power; Stream 2—water; Stream 3—H2; Stream 4—O2; Stream 5—CO2; Stream 6—CO2C reactor feed; Stream 7—CO2C product; Stream 8—portion of CO2C product; Stream 9—hydrocarbons; Stream 10—water; Stream 11—CO2 and other recycle to Unit 2; Unit 1—electrolyzer; Unit 2—CO2C reactor; Unit 3—product processing unit.

FIG. 2 shows the CO₂C process as described in Example 2, where the components are: Unit 200—CO2C reactor; Unit 201—water knockout; Unit 202—amine contactor; Unit 203—amine regenerator; Unit 401—syngas methanation reactor system; Unit 402—methanation reactor product separator; Stream 301—feed to CO2C Rx; 302—reactor effluent; 303—water; 304—methane, H2, CO2; 305—methane H2 feed to 401; 306—CO2; 307—methanation reactor effluent; 308—methane; 309—CO2; 310—methanation produced water; 311—CO2/amine solution; 312—amine to contactor; 313—medium pressure stream.

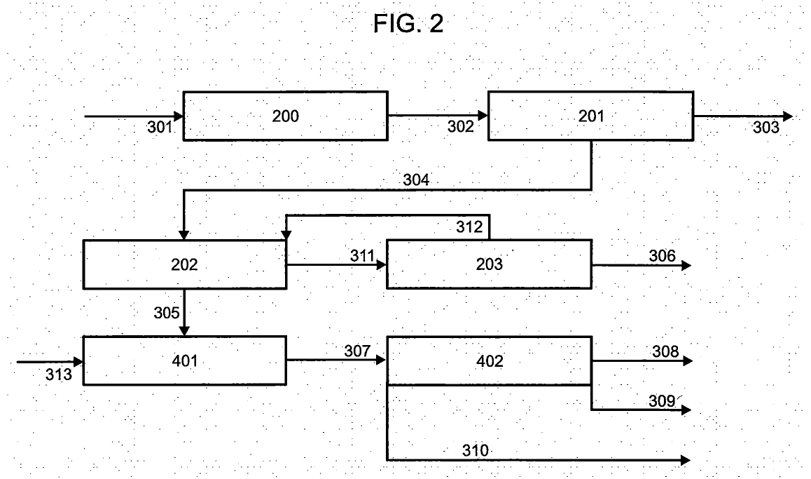

### DETAILED DESCRIPTION OF THE INVENTION

Hydrocarbons refer to a class of organic chemical compounds composed only of the elements carbon and hydrogen. The hydrogen atoms are attached to the carbon atoms in many different configurations. Hydrocarbons are classified as either aliphatic or aromatic. Aliphatic hydrocarbons are classified as alkanes, alkenes, and alkynes. Aromatic hydrocarbons are classified as arenes, which contain a benzene ring as a structural unit, or non-benzenoid aromatic hydrocarbons which lack a benzene ring as a structural unit.

C₁-C₅ Hydrocarbons refer to hydrocarbons that contain between 1 carbon atom and 5 carbon atoms.

C₂-C₅ Hydrocarbons refer to hydrocarbons that contain between 2 carbon atom and 5 carbon atoms.

C₅₊ Hydrocarbons refer to hydrocarbons that contain 5 or more carbon atoms.

Renewable Electric Power refers to an energy source that is not fossil carbon-based and may include solar, wind, biomass, geothermal, landfill gas, wave, tidal and thermal ocean technologies. Although nuclear energy itself is a renewable energy source, the material used in nuclear power plants is not unless the spent nuclear fuel is recyclable. At this point in time, about 96% of spent nuclear fuel in reactors is recycled.

Low-Carbon Electric Power refers to electricity produced with substantially lower greenhouse gas emissions than conventional fossil fuel power generation.

Precious metals refer to rare, naturally occurring metallic chemical elements of high economic value. Precious metals include gold, silver, platinum, palladium, ruthenium, rhodium, osmium, and iridium.

Natural Magnetite refers to a naturally occurring iron oxide mineral. It is composed primarily of Fe₃O₄ with minor amounts of precious metals. It is the most magnetic of all the naturally occurring minerals on Earth—It is a natural magnet. Magnetite-rich “black sands” are commonly encountered in gold mining operations. Precious metals often occur in magnetic concentrates as discrete mineral grains, as inclusions in magnetite, and as diffused atoms. in the magnetite lattice. The precious metal content may vary from a few ppm to 1,500 ppm, depending upon the mineral source.

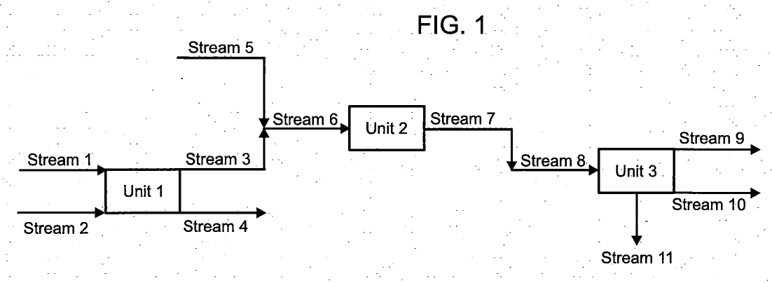

Synthetic Magnetite refers to the impregnation of synthetic Fe3O4 with up to 1,500 ppm of various precious metals followed by calcining up to about 2,100° F. FIG. 1 shows an integrated process for the production of hydrocarbons. Feed stream 1 is low carbon electricity. Low carbon power includes but is not limited to wind power, solar power nuclear power, power generated from biomass or renewable natural gas, and hydropower. Feed stream 2 is water. These two feed streams are used in Unit 1, the electrolyzer. In the electrolyzer, water and low carbon energy are used to produce hydrogen and oxygen. Hydrogen is produced by electrolysis of water.

$${H}_{2} O = {H}_{2} + \frac{1}{2} {O}_{2}$$

Electrolyzers consist of an anode and a cathode separated by an electrolyte. Different electrolyzers function in slightly different ways. Different electrolyzer designs that use different electrolysis technology that are used include alkaline electrolysis, polymer electrolyte membrane (PEM) electrolysis, solid oxide electrolysis, high temperature electrolysis and other emerging types of electrolysis.

The products from the electrolyzer are a stream comprising hydrogen called stream 3 in FIG. 1 and a stream comprising oxygen called stream 4. Because of the renewable or low carbon energy sources, the electrolyzer produces green hydrogen. Other forms of hydrogen generation that may use renewable or non-renewable energy sources may also be used, including methane pyrolysis, steam reforming of hydrocarbons with or without carbon capture, biomass gasification, renewable natural gas (RNG) reforming or sourcing hydrogen from geological sources; in each of these alternatives, purification of the stream may be required to produce hydrogen for use in a process.

In FIG. 1, stream 5 is a stream that comprises CO₂. CO₂ is obtained from several sources. Power plants that generate electricity from various carbonaceous resources produce large amounts of CO₂. Industrial manufacturing plants that produce ammonia for fertilizer produce large amounts of CO₂. Ethanol plants that convert corn or wheat into ethanol produce large amounts of CO₂ via fermentation. Other industrial fermentation processes also produce large amounts of CO₂. Municipal sewage treatment systems using aerobic and anaerobic digestion of sludge produce large amounts of CO₂. Utilization or conversion of CO₂, as described herein, typically involves separating and purifying the CO₂ from a gaseous stream where the CO₂ is not the only component, and often not the major component (e.g., exhaust flue gas). Typically, an alkylamine is used to remove the CO₂ from the gas stream. Alkylamines used in the process include monoethanolamine, diethanolamine, methydiethanolamine, disopropylamine, aminoethoxyethnol, or combinations thereof. Metal Organic Framework (MOF) materials have also been used as a means of separating CO₂ from a dilute stream using chemisorption or physisorption to capture the CO₂ from the stream. Other methods to get concentrated CO₂ include chemical looping combustion where a circulating metal oxide material captures the CO₂ produced during the combustion process. CO₂ can also be captured from the atmosphere in what is called direct air capture (DAC). The processes for the capture of CO₂ often involve regeneration of the capture materials. Alkylamines are regenerated by being heated, typically by low pressure steam.

Captured CO₂ which is converted into useful products such as fuels (e.g., synthetic natural gas, diesel fuel, gasoline blend stocks, jet fuel, other) and chemicals (e.g., solvents, olefins, alcohols, aromatics, polymers (for textiles, packaging, structural materials, etc., and others), displace fuels and chemicals produced from fossil sources such as petroleum and natural gas, lowering the total net emissions of CO₂ into the atmosphere. This is what is meant by low carbon, very low carbon, zero carbon, or negative carbon fuels and chemicals.

The CO₂ stream that comes from industrial or biological process, or is captured from the atmosphere, or that is available from a commercial CO₂ pipeline is not generally pure CO₂. These available CO₂ streams from industrial facilities or pipelines can include sulfur containing compounds from none to 2000 parts per million by weight and contain hydrocarbons from none to 10 volume percent. Purification of the CO₂ including the removal of sulfur containing compounds and hydrocarbons is necessary to avoid issues with downstream processing. After purification, the purified CO₂ is suitable for the generation of low carbon or zero-carbon fuels and chemicals as per the invention.

At least a portion of the stream 3 comprising hydrogen is blended with the stream 5 comprising CO₂ to produce a stream 6 or CO₂C Reactor feed stream. The ratio of H₂/CO₂ is from 2 to 6, or preferably from 3 to 4. The CO₂ and hydrogen in stream 6 are reacted to products in a CO₂C reactor shown as Unit 2 in FIG. 1. The CO₂C reactor operates at temperatures of 250 to 425° C., more preferably from 275 to 350° C., and even more preferably at about 300° C. The primary reactions that may occur in the CO₂C reactor are the following:

CO₂+H₂═CO+H₂O (ΔH₂₉₈=+42.1 kJ/mole) Eq. 1

CO+3H₂═CH₄+H₂O (ΔH₂₉₈=−206.1 kJ/mole) Eq. 2

nCO+(2n+1)H₂→CₙH₍₂ₙ₊₂₎+nH₂O (ΔH₂₉₈=−165 kJ/(mol CO)) Eq. 3

The first reaction, Eq. 1, is the Reverse Water Gas Shift reaction. At standard temperature, the reaction is endothermic and in other processes requires much higher temperatures than the preferred CO₂C reactor temperatures. The second reaction, Eq. 2, is the methanation reaction where CO and hydrogen gas are reacted to produce methane and water. Methanation is very exothermic as can be seen with the high negative enthalpy of reaction. The third reaction, Eq. 3, is the desired Fischer-Tropsch (F-T) reaction. The F-T reaction is also very exothermic.

Catalyst is used in the CO₂C reactor to facilitate the chemical reactions. Various catalysts can be used in the CO₂C reactor. Catalysts include multiple components of different functionality. Catalysts may be monofunctional, bifunctional or multifunctional formulations comprising many different elements including nickel, magnesium, aluminum, iron, copper, cobalt, indium, sodium, silicon, manganese, zinc, chromium, rhodium, carbon, cerium, titanium, and zirconium. Specifically, catalysts include unsupported Ni₂Mg unsupported solid solution catalyst, Mg/Mg-aluminate catalyst, Rhodium on gamma alumina, CuFeO₂, Fe—Co/K/Al₂O₃, In₂O₃/HZSM-5, Na—Fe₃O_{4/}HZSM-5, FeNa, Na—Fe₂O₄/HMCM-22, Fe₂O₃, Co₆/MnO₄, Zn—Cr/Hy, Fe—Zn—Zr/HZSM-5, Fe—Mn—K, and other catalysts as shown in the review paper of Tan et al (2022) or in Yao et al (2020).

The product from the CO₂C reactor is shown as stream 7 in FIG. 1. At least a portion of stream 7 becomes stream 8 and is fed to the Product Processing unit, Unit 3 in FIG. 1. The product processing unit can be a combination of various processes that allow the separation or additional processing of the CO₂C reactor product stream. Various embodiments are made depending on the products, yields, and selectivity observed in the CO₂C reactor. Each of the reactions that occur in the CO₂C reactor produces water. So, the first step in the product processing unit is to reduce the temperature of the reactor product stream. This can be done by many different means including heat exchange with the cooler feed stream, heat exchange with another cooler stream, and with a cooling water heat exchanger. The objective of the cooling is to allow the condensation of water and/or C₅₊ hydrocarbons that may be produced in the CO₂C. As is well known, C₅₊ hydrocarbons are generally insoluble in water. A three-phase separator or sequential two-phase separators can be used after the effluent stream is cooled. This allows the separation of the water and C₅₊ from the reactor effluent.

In one embodiment, the CO₂ conversion in the CO₂C reactor is less than about 90%, and the unreacted CO₂ is removed prior to further processing after the water and C₅+ hydrocarbon removal. CO₂ removal from the stream can be done by any number of available techniques. The removal methods include the use of physical solvents. Physical solvents include refrigerated methanol that is used in the Rectisol process and the Solexol process that uses dimethyl ethers of polyethylene glycol to capture the CO₂ from the gas stream. Other means include the use of membranes selective for CO₂ removal. Another means for CO₂ removal is to use aqueous solutions of alkylamines (referred to as amines) to chemically capture the CO₂. The amine contactor captures the CO₂ in the solution. The overhead of the amine contactor is the CO₂ free gas and the amine solution with the CO₂ is heated in an amine regenerator where the CO₂ is released, and the amine aqueous solution is recycled back to the contactor. Various amines can be used such as diethanolamine (DEA), monoethanolamine (MEA), methyl-diethanolamine (MDEA), and Diisopranolamine (DIPA).

The CO₂ stream recovered from the CO₂ capture unit is shown as Stream 11 in FIG. 1. The stream is compressed and recycled and blended with the CO₂ feed stream, as shown as stream 5 in FIG. 1.

In one embodiment, the CO₂C hydrocarbon product stream comprises n-alkanes with carbon numbers from 6 to 23 that is fed to an CO₂C separation unit where at least three product fractions are produced. The CO₂C separation is any separation process such as absorption, adsorption, filtration, or distillation—or a combination of those processes. Distillation is a preferred separation process. The light CO₂C separation product comprises n-alkanes with carbon numbers, between 5 and 9. The medium CO₂C separation product comprises n-alkanes from carbon numbers between 9 and 15.

The heavy CO₂C separation product comprises n-alkanes with carbon numbers between 16 and 23. Hydrocarbons produced in the CO₂C reactor are represented (collectively) as Stream 9 in FIG. 1.

In one embodiment of the invention, the CO₂C reactor is a mix of two different catalysts that can produce hydrocarbons from mixtures of CO₂ and H₂.

The first catalyst, catalyst #1, is a CO₂ hydrogenation catalyst that has a CO₂ conversion efficiency of about 25% and a high CO selectivity (>90%) at 300° C. with an H₂/CO₂ feed ratio of about 3.0-3.5/1.0, a pressure of 250-350 psig, and a space velocity of 2,000-3,000 hr⁻¹. This is an endothermic catalyst (ΔH₂₉₈=˜+40 kJ/mole) which requires the input of heat.

The second catalyst, Catalyst #2, can be any F-T catalyst that is capable of producing hydrocarbons at 300° C. Iron based catalysts are well known to be active for F-T at this temperature. One particularly useful catalyst is a magnetite-based catalyst that operates in the same temperature range of catalyst #1 (300° C.). This is an exothermic catalyst (ΔH₂₉₈=˜−200 kJ/mole of CO which produces hydrocarbons from the CO and H₂ formed from catalyst #1. This catalyst operates with a H₂/CO feed ratio of about 1.5-2.0/1.0, a pressure of 250-350 psi, and a space velocity of 2,000-3,000 hr⁻¹.

The first and second catalyst are mixed in a ratio and physical proximity such, that the exothermic heat from catalyst #2 is directly transferred to the adjacent endothermic catalyst #1. It is estimated that the ratio of catalysts #1 and #2 should be 4-5 to 1 for the catalyst bed to remain isothermal and for there to be enough CO available for catalyst #2 from catalyst #1. The catalytic reactor is held under adiabatic conditions by using sufficient insulation and heat to keep the bed at 300° C.

Catalyst #1 can be any suitable CO₂ hydrogenation catalyst. Since titanium oxide has the highest surface acidity of any catalyst substrate, TiO₂ is preferred as the substrate for catalyst #1. Zirconium oxide also has a high surface acidity, but lower than that of titanium oxide.

The impregnation of certain metals on the support of catalyst #1, such as Cu, on TiO₂ will increase the reaction rate. The CO₂ conversion should be about 25% at about 2,000-3,000 hr⁻¹ space velocity with a high CO selectivity and minimal CH₄ formation at 300° C.

Since the CO produced by catalyst #1 is generated quickly, a highly efficient oligomerization (chain propagating) catalyst (catalyst #2) needs to be mixed with or placed in tandem (close proximity) with the hydrogenation catalyst, catalyst #1. In addition, this chain propagating catalyst needs to operate efficiently at 300° C.

In one embodiment, magnetite or iron-based catalysts are used for catalyst #2. Depending upon the source, natural magnetite contains from about 50 to 1,500 ppm of precious metals and may be used as the catalyst. In another embodiment, a synthesized magnetite or iron catalyst is used with the desired promoters incorporated into the catalyst which may include precious metals. The precious metals in the magnetite significantly increases the production of H· radicals from H₂, which reduces the probability of free radical chain propagation and thereby decreases the formation of higher molecular weight hydrocarbons species.

In one embodiment of the invention, the CO₂C reactor is a multi-tubular fixed bed reactor. The inner reactor tubes are filled with a mixture of steam and water. The reaction heat is removed through the production of steam in the shell of the reactor. The inner diameter of the tubes is between 18 and 50 mm. The tubes are filled with catalyst particles. The catalyst particle size is optimized to optimize the tradeoff between conversion and pressure drop across the reactor. This small diameter of the reactor tubes means that as the feed gas reacts on the catalyst, the heat must be transferred from no more than 9 to 25 mm (one-half of the diameter of the tube) to the heat transfer surface. Outside of the tubes, the mixture of steam and water allow heat transfer primarily through nucleation in the vaporization of the liquid water to steam. The water comes from a steam drum. Boiler Feed Water (BFW) is fed to the steam drum and circulates the system. The pressure of the steam system sets the temperature of the steam/water mixture. The pressure of the steam ranges from 200 to 1600 psig. At 1200 psig (82.7 barg), the temperature of saturated steam is 298° C. At 1100 psig (75.8 barg), the temperature of saturated steam is 292° C. At 1000 psig (69.0 barg), the temperature of saturated steam is 285° C. As such, saturated steam from 1000 to 1200 psig is an ideal cooling fluid for the CO₂C reaction that occurs at 300° C. Typically, water is fed from the steam drum to the water entrance to reactor shell and a mixture of about 50% steam and 50% water is at the steam exit of the reactor shell back to the steam drum.

In one embodiment, heat transfer is done with a hot oil system. Oil as a working fluid is pumped to the reactor shell. Heat is transferred from the tubes to the oil raising the temperature of the oil. The rate of oil circulation is controlled by the pumping rate that sets the heat removal rate. The hot oil leaving the reactor shell is cooled in an external heat exchanger. Cooling water, refrigerated water, or propylene glycol or other suitable materials can be used in the cold side of the external heat exchanger to reduce the temperature of the hot oil back to the desired reactor shell inlet temperature. The cooled hot oil is then pumped back to the reactor shell. Several suitable oils have working temperatures that are useful for this service including Therminol XP, Therminol 55, Therminol SP, Therminol 59, or any equivalent or similar oil working fluid.

In one embodiment, the catalyst inside the CO₂C reactor can be diluted with other, non-reactive solids. Dilution of the catalyst aids in the heat transfer so that the rate of exothermic heat generation per unit volume is less and as such the local temperature rise is less. Suitable diluents include alumina, silicon carbide, spinels, or other refractory materials. Silicon carbide has one advantage as its thermal conductivity is higher and as such could transfer heat from the exothermic heat generation at a higher rate. However, any non-catalytically active material can be used as the diluent.

In one embodiment, metal partitions can be placed inside the CO₂C reactor tubes prior to the addition of the catalyst such that from the center of the tube to the wall of the tube there are metal pathways or connections. This aids in heat transfer since the high thermal conductivity of the metal increases the rate of heat transfer from the hot center of the tube to the cooled tube walls.

In one embodiment of the invention, the feed gas to the CO₂C reactor can be diluted with non-reactive gases. Feed gas dilution aids in heat transfer and temperature control in several ways. It reduces the reaction heat generated per unit time per unit volume. It also adds additional mass flow rate that acts as a heat sink. Various dilution gases can be used. The ideal dilution gas is easily separable from the reactor effluent. Low pressure steam can be used as a diluent gas feed to the CO₂C reactor. As the reactor effluent is cooled, the condensed steam can easily be removed from the effluent by a knockout vessel or separator and since steam is a reaction product, the design change involves just increasing the size of the separator.

In one embodiment, the CO₂C reactor is a series of adiabatic reactors or reactor beds. Each reactor bed length or residence time is set such that the maximum conversion that can occur keeps the bed temperature rise to a preset temperature rise of no more than 50° C., preferable less than 25° C., more preferably less than 10° C. Catalyst and feed gas dilution can also be used to keep the temperature rise to the preset limit. At the outlet of the reactor bed, the effluent gas is cooled in a heat exchanger that produces high pressure saturated steam in the range of 1000 to 1200 psig. This cools the reactor effluent to a temperature similar to the previous bed inlet temperature. The cooled effluent is then fed to a subsequent bed. The total number of beds is chosen to get the desired overall CO₂ conversion. Optionally, additional hydrogen or hydrogen and CO₂ can be added to the subsequent bed feed gas.

In one embodiment, the heat transfer and heat management in the reactor are controlled using sequential H₂ injection. The initial H₂/CO₂ ratio is below stoichiometric for the net reaction. This keeps the CO₂ conversion low, and the temperature rise in the reactor bed low. H₂ at a temperature substantially below the reactor bed temperature is added at the end of the bed. The cold H₂ lowers the overall gas temperature to about the previous bed inlet temperature. The additional hydrogen with the previous bed CO₂ reacts in the subsequent bed. In essence, the conversion is spread (stretched) over a longer effective bed depth (or bed number), reducing the amount of heat generated per reactor area or volume—making the heat removal more manageable. The number of reactor beds and cold hydrogen additions sets the overall CO₂ conversion.

In one embodiment, the CO₂C reactor is operated at low CO₂ conversion but with high overall gas recycle. This allows the temperature in the reactor bed to be controlled and the temperature rise within the acceptable range. The space velocity or residence time in the reactor bed is high such that conversion is low. Gas dilution and catalyst dilution can be used to aid in the control of the temperature. The per pass CO₂ conversion is kept below 30%, preferably below 20%, more preferably below 10%. The reactor effluent is fed to the Product Processing Unit where the water in the effluent is removed by cooling and separation and the unreacted CO₂ and H₂ are removed and compressed and recycled and blended with the fresh feed to the CO₂C reactor.

### EXAMPLE 1

In this example, which has been performed, two different catalysts were mixed in the CO₂C reactor. Catalyst #1 was an improved high-surface area copper aluminate (CuAl₂O₄) spinel impregnated with 0.05—5.0 wt % Cu that had been formed into pellets and calcined. Catalyst #2 was a natural magnetite-based catalyst that has been pressed into pellets and calcined. The catalysts were placed in close proximity to each other in the reactor. Catalyst #1 operates endothermally (requires heat) whereas catalyst #2 operates exothermally (produces heat).

These catalysts were mixed in specified ratios so that they operate isothermally throughout the catalytic reactor. H₂ produced from the electrolysis of water using renewable or low carbon electricity was mixed with captured CO₂.

Since the catalysts in the catalytic reactor operated under or near isothermal conditions, CO₂C reactor design can be chosen from one of many isothermal reactors currently available including a multi-tubular fixed bed reactor.

The H₂ and CO₂ were individually heated to the desired temperature of about 315° C. and mixed in specific ratios before introduction into the catalytic reactor.

Details on the production and composition of catalyst #1 and catalyst #2 are as follows.

Catalyst #1 was a copper aluminate (CuAl₂O₄) spinel that was formed from mixing a mixture of copper salt and high surface area gamma-alumina powder in which enough extra copper was added such that the resulting catalyst was a copper aluminate spinel in which 0.05-5.0 wt % copper was distributed on the spinel. The copper salts may include copper acetate, copper nitrate, or other copper water-soluble salts. The mixture was then formed into tablets at high pressure. These tablets were calcined at about 950° C. which forms the CuAl₂O₄ spinel. The resulting CuAl₂O₄ catalyst had a BET surface area greater than 10 m²/g, preferably a surface area of greater than 25 m²/g, and more preferably a surface area greater than 50 m²/g.

An alternative approach for the production of the catalyst is to dissolve copper acetate in water and enough solution is added to the copper aluminate spinel to produce 0.05—10.0 wt % of Cu impregnated on the copper aluminate (CuAl₂O₄) spinel.

This Cu—CuAl₂O₄ catalysts converted CO₂/H₂ mixtures with about a 25% CO₂ conversion and a CO selectivity greater than 90% at 300° C. and at a CO₂/H₂ molar feed ratio of 3.5/1.0 and at a space velocity of 3,000 hr⁻¹ and a pressure of 300 psi (Table 3).

TABLE 3
The Effect of Space Velocity for the CO₂ Conversion
to CO for Catalyst #1 at 300° C.

| Space Velocity (hr⁻¹) | % CO₂ Conversion to CO |
|---|---|
| 3,000 | 25 |
| 6,000 | 23 |
| 12,000 | 20 |
| 30,000 | 11 |
| 40,000 | 6 |

Catalyst #2 was a magnetite catalyst that is based upon natural occurring magnetite which is found in select areas of North America. This natural magnetite which contains small amounts of precious metals is typically a side product of gold mining. The magnetite is formed into tablets at high pressure. These tablets are then calcined at about 950° C. In this example, the composition of the magnetite was Fe₃O₄ (94.4%) with Al₂O₃ (3.2%), TiO₂ (1.8%), CuO (0.22%), MnO (0.17%), MgO (0.10%), and about 850 ppm of precious metals. In another embodiment, the catalyst was synthesized generally to achieve the desired composition. The precious metals in order of abundance are Au, Ag, Pt, and Pd. These precious metals were widely dispersed in 100-250 Angstrom clusters throughout the Fe₃O₄ matrix, and they were primarily distributed on the surfaces of the magnetite crystals. The surface area of the magnetite catalyst was 3-4 m²/g with pores in the 10-100 Angstrom (1-10 nanometer) size range. The magnetite catalyst was reduced with H₂ at 300° C. in the catalytic reactor.

The effect of temperature on the performance of the magnetite catalyst (catalyst #2) in an oligomerization reaction such as a Fischer-Tropsch reaction is summarized in Table 4. The production of C₅+ hydrocarbons was about 39% with the remaining carbon containing products (CH₄, CO₂, C₂-C₅ hydrocarbons and C₂₄₊ hydrocarbons) accounting for the other 61% at 300° C. When this exothermic catalyst is coupled in a short length scale with the endothermic catalyst, catalyst #1, the result is a direct conversion for CO₂ and hydrogen to hydrocarbons. In this example, hydrogen was produced from the electrolysis of water. Additionally, oxygen was produced by the electrolyzer.

Catalyst #1 catalyzes an endothermic reaction (about +50 kJ/mole) which requires heating and catalyst #2 catalyzes an exothermic reaction (about −175 kJ/mole) which produces heat. Catalyst #1 and catalyst #2 were mixed in the proper proportions such that the heat produced from catalyst #2 was used to heat catalyst #1. Therefore, the masses of the first and second catalyst were adjusted such that the catalytic reactor operates isothermally at about 300° C. Based upon the thermodynamics, the mass ratio of catalyst #1/catalyst #2 of 3.0-5.0/1.0 provided a nearly thermal balance in the catalytic reactor.

Since there were 3-5 times more catalyst #1 than catalyst #2, more CO was produced than can be used by catalyst #2 even though the conversion efficiency of CO₂ to CO is only about 25% for catalyst #1.

Although catalyst #2 produces CO₂, the first catalyst converts the CO₂ to additional CO. As a result, the composition of the products from the two catalysts in the catalytic reactor averaged 20% CH₄, 24% C₂-C₅ and 56% C₆-C₂₄ for three passes. In addition, some CO₂, CO, and H₂ was present in the tail-gas.

In this example, the CO₂ C reactor effluent was cooled. The water was removed by a water knockout. The C₅₊ hydrocarbons were condensed and separated. After the C₅₊ hydrocarbons were condensed and collected, the remaining CO₂ and C₁-C₅ in the tailgas (44% total) were recycled by being sent to an oxyfuel combustor where the hydrocarbon and any remaining hydrogen and other combustible material were converted to additional CO₂ through the use of oxygen produced in the electrolysis unit. The CO₂ was then used as recycled feed to the catalytic CO₂C reactor. Therefore, after about 3 recycle loops, more than about 90% of the CO₂ carbon was converted to C₅₊ hydrocarbons. The product produced a mixture of hydrocarbons. Up to 30 vol % of the liquid products consisted of C₃-C₁₁ alpha-olefins and hydroxy-alkanes (alcohols) depending on the reactor operating conditions. The remainder of the liquid products consisted of C₅-C₂₄ normal alkanes, with a minor fraction of iso-alkanes.

The CH₄, C₂-C₅, CO and H₂ in the tail gas can be used as energy for the process, or it may be converted using oxy-combustion to produce additional CO₂ and CO.

The oxyfuel combustor used in this example works in the following way. CO₂ was mixed with oxygen as oxidant for the combustor. The fuel to the combustor is the CO₂C effluent that comprises CO₂, H₂, and the C₁-C₅ fraction produced by the CO₂C reactor. The combustion products were water and CO₂. The combustion products are cooled, and the water is removed. The CO₂ was recirculated and blended with the oxygen to produce the oxidant stream for the combustor. Alternatively, the CO₂ can be blended with the feed to the CO₂C reactor.

TABLE 4
The Effect of Temperature on Performance of the Natural
Magnetite Catalyst with 0.22 wt. % CuO
(H₂/CO = 2.0/1.0; P = 391 psi; SV = 3,200 hr⁻¹

| | CO | | | | | |
|---|---|---|---|---|---|---|
| | Conversion | Product Selectivity (%) | | | | |
| T ° F. (° C.) | (%) | CH₄ | CO₂ | C₅—C₂₄ | C₂—C₅ | C₂₄₊ |
| 380 (193) | 9 | 10.8 | 3.3 | 73.5 | 6.2 | 6.2 |
| 410 (210) | 21 | 11.5 | 7.1 | 65.1 | 11.8 | 4.5 |
| 435 (224) | 32 | 11.8 | 13.1 | 58.8 | 12.9 | 3.4 |
| 450 (232) | 38 | 12.3 | 16.4 | 54.6 | 14.1 | 2.6 |
| 470 (243) | 43 | 12.6 | 19.3 | 51.6 | 14.2 | 2.3 |
| 550 (288) | 63 | 13.7 | 26.5 | 41.1 | 16.6 | 2.1 |
| 570 (300) | 68 | 14.1 | 27.5 | 39.1 | 17.0 | 2.3 |
| 600 (315) | 74 | 14.2 | 28.1 | 38.8 | 16.9 | 2.0 |

### EXAMPLE 2

In this example, which has been performed, two catalysts were used in the CO₂C reactor. Catalyst #1 consists of Cu impregnated on a high surface area titanium oxide (TiO₂) substrate (e.g., Cu—TiO₂) instead of the copper aluminate. Catalyst #2 is the same as previously described in Example 1.

Catalyst # 1 was prepared by wet impregnation. The copper salt was suspended in a solvent. The high-surface TiO₂ substrate was added to the solution. The solvent was removed by evaporation so that the copper is deposited on the support. The mixture was then formed into tablets at high pressure. These tablets were calcined at about 950° C. which formed the Cu—TiO₂ catalyst. The resulting Cu—TiO₂ catalyst had a BET surface area greater than 10 m²/g, preferably a surface area of greater than 25 m²/g, and more preferably a surface area greater than 50 m²/g.

An alternative approach to produce the catalyst is to dissolve copper acetate in water and enough solution is added to the copper Cu—TiO₂ to produce 0.05-10.0 wt % of Cu impregnated on the Cu—TiO₂ material.

The CO₂C reactor was operated as shown in Example 1 and results in more than about 90% of the CO₂ carbon converted to C₅₊ hydrocarbons after recycling. The product produced a mixture of hydrocarbons. Up to 30 vol % of the liquid products consisted of C₃-C₁₁ alpha-olefins and hydroxy-alkanes (alcohols) depending on the reactor operating conditions. The remainder of the liquid products consisted of C₅-C₂₄ normal alkanes, with a minor fraction of iso-alkanes.

The CH₄, C₂-C₅, CO and H₂ in the tail gas can be used as energy for the process, or it may be converted using oxy-combustion to produce additional CO₂ and CO.

### EXAMPLE 3

In this example, which has been performed, the catalyst in the CO₂C reactor used the Fe₃O₄ (magnetite) catalyst that has been impregnated with 0.1-10.0 wt. % copper. The reactor was a multi-tubular fixed bed reactor using hot oil to help maintain a constant catalyst temperature. The H₂/CO₂ in the feed to the CO₂C reactor was 3.0-4.0, pressure was 250-350 psi, and the reactor is operated at 300° C. The CO₂ conversion is 38% with a CH₄ selectivity of 10.4%, C₂-C₅ selectivity of 27.7% and C₅₊ selectivity of 61.9%. The CO₂C reactor effluent comprises'a mixture of hydrogen, CO, CO₂, C₁-C₅ hydrocarbons, and C₅+ hydrocarbons. Downstream of the CO₂C reactor, a large fraction of the C₅+ hydrocarbons were condensed to a liquid via a cooling water exchanger and a knockout vessel and sent to product storage. The remaining stream of H₂, CO, CO₂, C₁-C₂ was sent to a CO₂ removal unit, typically an amine unit, where the CO₂ was removed. The CO₂ rich stream was compressed and recycled to the inlet of the CO₂C reactor. Additional hydrogen was fed to the reactor to maintain the H₂/CO ratio in the feed at 3.0-4.0. The CO, H₂ and C₁-C₅ stream were additionally separated and used as plant fuel gas, converted to additional CO₂ and CO, or sold as a fuel product.

### REFERENCES

Landau et al., AU 2015203898 B2 (2015).

National Academy of Sciences, Chemical Utilization of CO₂ into Chemicals and Fuels, Gaseous Carbon Waste Streams Utilization: Status and Research Needs, National Academies Press, Washington D.C. (2019).

Pan, et al., Enhanced Ethanol Production Inside Carbon Nanotube Reactors Containing Catalytic Particles, Nature Materials, Volume 6 (2007).

Shen et al., Identifying the Roles of Ce³⁺—OH and Ce—H in the Reverse Water-Gas Shift Reaction Over Highly Active Ni-doped CeO₂ Catalyst, Xi'an Key Laboratory Functional Organic Porous Materials, School of Chemistry and Chemical Engineering, Northwestern Polytechnical University, Xi'an 710129, China (2022).

Tan, et al., Current Developments in Catalytic Methanation of Carbon Dioxide—A Review, Frontiers in Energy Research (2022).

Wang et al., High Performance MₐZrOₓ (Mₐ=Cd, Ga) Solid-Solution Catalysts for CO₂ Hydrogenation to Methanol, State Key Laboratory of Catalysis, Dalian Institute of Chemical Physics, Chinese Academy of Sciences, Dalian, China (2019).

Wang et al., One-Step Plasma-Enabled Catalytic Carbon Dioxide Hydrogenation to Higher Hydrocarbons: Significance of Catalyst-Bed Configuration, Green Chemistry (2021).

Wei et al., Catalytic Hydrogenation of CO₂ to Isoparaffins over Fe-Based Multifunctional Catalysts, Dalian National Laboratory for Clean Energy, Dalian Institute of Chemical Physics, Chinese Academy of Sciences, Dalian, China (2018).

Williamson et al., N-Doped Fe@CNT for Combined RWGS/FT CO₂ Hydrogenation, ACS Sustainable Chemical Engineering (2019).

Yao, et al, Transforming Carbon Dioxide into Jet Fuel Using an Organic Combustion-Synthesized Fe—Mn—K Catalyst, Nature Communications, 11, 6395 (2020).

1. A process for the production of hydrocarbons comprising:
a. mixing a first feed stream comprising CO₂ with a second feed stream comprising renewable H₂ to produce a CO₂ reactor feed stream;
b. feeding the CO₂ reactor feed stream into a CO₂ conversion reactor, wherein the CO₂ conversion reactor comprises two catalysts, thereby producing a reactor product stream comprising C⁵⁺ hydrocarbons, H₂O and unreacted H₂, CO and CO₂.

2. The process of claim 1, wherein the reactor product stream is subjected to a separation step, producing a purified product stream comprising liquid product and a gas-phase product, wherein the liquid product comprises C⁵⁺ hydrocarbons and the gaseous product comprises C¹-C⁵ hydrocarbons, CO₂, H₂O, CO and H₂.

3. The process of claim 1, wherein the H₂ in the second feed stream is produced from the electrolysis of H₂O using renewable or low-carbon electric power.

4. The process of claim 1, wherein the CO₂ in the first feed stream is captured from stationary sources or ambient air.

5. The process of claim 1 wherein the CO₂ conversion reactor is an isothermal catalytic reactor that is insulated to prevent heat loss.

6. The process of claim 5, wherein the first feed stream and the second feed stream are separately heated to between 310° C. and 320° C. and subsequently mixed at a volume/volume ratio between 3.0 and 5.0 before input into the CO₂ conversion reactor.

7. The process of claim 5, wherein one catalyst in the CO₂ conversion reactor is an endothermic catalyst, wherein the endothermic catalyst comprises 0.05-10 weight percent copper impregnated on a copper aluminate spinel or titanium oxide, and wherein the catalyst has a surface area greater than 10 m²/g.

8. The process of claim 5, wherein one catalyst in the CO₂ conversion reactor is an exothermic catalyst, wherein the exothermic catalyst comprises magnetite, and wherein the magnetite comprises between 94 weight percent and 99.9 weight percent Fe₃O₄ and between 50 ppm and 500 ppm of a precious metal.

9. The process of claim 5, wherein one catalyst in the CO₂ conversion reactor is an exothermic catalyst, and wherein the exothermic catalyst comprises between 99 weight percent and 99.9 weight percent Fe₃O₄, and wherein the catalyst has been impregnated with between 1 ppm and 2,000 ppm of gold.

10. The process of claim 5, wherein there is a first catalyst and a second catalyst in the CO₂ conversion reactor, and wherein the first catalyst is an endothermic catalyst and the second catalyst is an exothermic catalyst, and wherein the exothermic catalyst generates heat when reacting with the CO₂ reactor feed stream, and wherein the heat generated from the exothermic catalyst is used to heat the endothermic catalyst, and wherein the step of producing the product stream using the endothermic and exothermic catalysts is isothermal.

11. The process of claim 2, wherein the reactor product stream is fed to a product processing unit that separates the liquid products from the gas-phase products.

12. The process of claim 11, wherein the gas-phase products are recycled back into the isothermal catalytic reactor, thereby producing additional C⁵⁺ hydrocarbon products.

13. The process of claim 11, wherein the H₂ in the second feed stream is produced from the electrolysis of H₂O using renewable or low-carbon electric power, and wherein the gas-phase products are mixed with oxygen generated from the electrolysis to provide an oxygenated mixture, and wherein the oxygenated mixture if fed into an oxyfuel combustor to produce additional CO₂ and CO, and wherein the additional CO₂ and CO is recycled back into the isothermal catalytic reactor to produce additional liquid C⁵⁺ hydrocarbon products.

14. The process of claim 12, wherein the conversion efficiency of CO₂ to liquid hydrocarbon products is between 30 percent and 95 percent.

15. The process of claim 13, wherein the conversion efficiency of CO₂ to liquid hydrocarbon products is between 30 percent and 95 percent.

16. The process of claim 1, wherein the CO₂ conversion reactor is a fixed bed catalytic reactor.

17. The process of claim 1, wherein one of the catalysts in the CO₂ conversion reactor comprises natural magnetite impregnated with 0.10-10.0 weight percent of copper.

18. The process of claim 1, wherein one of the catalysts in the CO₂ conversion reactor comprises synthetic magnetite impregnated with 0.10-10.0 weight percent of copper.

19. The process of claim 17, wherein the natural magnetite impregnated catalyst maintains an operating temperature by the production of steam on the outside of reactor tubes.

20. The process of claim 18, wherein the synthetic magnetite impregnated catalyst maintains an an operating temperature by the production of steam on the outside of reactor tubes.

21. The process of claim 17, wherein the natural magnetite impregnated catalyst maintains an operating temperature using a hot oil system on the outside of reactor tubes.

22. The process of claim 18, wherein the synthetic magnetite impregnated catalyst maintains an operating temperature using a hot oil system outside of reactor tubes.

23. The process of claim 17, wherein the CO₂ reactor feed stream is diluted with additional H₂ in excess of the stoichiometric ration.

24. The process of claim 18, wherein the CO₂ reactor feed stream is diluted with additional H₂ in excess of the stoichiometric ratio.

25. A process for the production of hydrocarbons comprising:
a. mixing a first feed stream comprising CO₂ with a second feed stream comprising renewable H₂ to produce a CO₂ reactor feed stream;
b. feeding the CO₂ reactor feed stream into a CO₂ conversion reactor, wherein the CO₂ conversion reactor is a multi-tubular fixed bed reactor, and wherein the CO₂ conversion reactor comprises two catalysts, wherein one of the catalyst comprises Fe₃O₄ impregnated with copper, thereby producing a reactor product stream comprising C⁵⁺ hydrocarbons, H₂O and unreacted H₂, CO and CO₂.

26. The process of claim 25, wherein the multi-tubular fixed bed reactor uses hot oil to maintain a constant temperature.

27. The process of claim 26, wherein the ratio of H₂/CO₂ in the reactor feed stream is between 2.75 and 4.25.

28. The process of claim 27, wherein there is a conversion rate of CO₂, and wherein the conversion rate is between 30 percent and 45 percent, and wherein there is a selectivity of product production, and wherein the selectivity of product production for C5+ hydrocarbons is between 50 percent and 70 percent.

29. The process of claim 28, wherein the other catalyst comprises copper aluminate spinel.

30. The process of claim 29, wherein the process is operated at a space velocity between 2,000 hr⁻¹ and 4,000 hr⁻¹.
